(19) United States
(12) Patent Application Publication
(10) Pub. No.: US 2021/0254698 A1
(43) Pub. Date: Aug. 19, 2021

(54) VEHICLE DIFFERENTIAL APPARATUS

(71) Applicant: Honda Motor Co., Ltd., Tokyo (JP)

(72) Inventor: Tetsuya Otani, Wako-shi (JP)

(21) Appl. No.: 17/169,848

(22) Filed: Feb. 8, 2021

(30) Foreign Application Priority Data
Feb. 18, 2020 (JP) 2020-024833

(51) Int. Cl. F16H 48/40; F16H 48/08; F16H 57/04

(52) U.S. Cl. CPC F16H 48/40; F16H 2048/087; F16H 57/0483; F16H 48/08

(57) ABSTRACT

A vehicle differential apparatus including a pair of side gears arranged side by side along an axial line so as to rotate about the axial line, a set of pinion gears disposed on a radial outside of the side gears so that one pinion gear engages with one of side gears, and the other pinion gear engages with the other of the side gears the one pinion gear, and a housing accommodating the side gears and the pinion gears and including a substantially cylindrical circumferential wall and a side wall extended radially inward from an end of the circumferential wall. The housing includes a space formation portion forming a housing space accommodating the pinion gears so as to rotate integrally with the pinion gears, and the side wall is provided with an opening connecting the housing space and a space outside the housing.

### CROSS-REFERENCE TO RELATED APPLICATION

This application is based upon and claims the benefit of priority from Japanese Patent Application No. 2020-024833 filed on Feb. 18, 2020, the content of which is incorporated herein by reference.

### BACKGROUND OF THE INVENTION

### Field of the Invention

This invention relates to a vehicle differential apparatus.

### Description of the Related Art

Conventionally, there is a known differential apparatus that include a pair of substantially cylindrical side gears in which a pair of left and right drive shafts are inserted, a set of pinion gears that are engaged with one and the other of the pair of side gears and also engaged with each other, and a housing that forms a space housing the pair of side gears and set of pinion gears. Such an apparatus is described in, for example, Japanese Patent Publication No. 5018505 (JP5018505B). In the apparatus of JP5018505B, during differential rotation of a pair of side gears, a set of pinion gears revolve integrally with a housing, as well as rotate in the housing.

In the case of an apparatus including a set of pinion gears that rotate in a housing, such as JP5018505B, lubricant oil has to be supplied to the pinions. However, it is difficult to efficiently supply the lubricant oil into the rotating housing.

### SUMMARY OF THE INVENTION

An aspect of the present invention is a vehicle differential apparatus including: a pair of side gears arranged side by side with each other along an axial line and formed in substantially cylindrical shapes so as to rotate about the axial line; a set of pinion gears disposed on a radial outside of the pair of side gears so that one of the set of pinion gears engages with one of the pair of side gears, the other of the set of pinion gears engages with the other of the pair of side gears, and the set of pinion gears engage with each other; and a housing configured to accommodate the pair of side gears and the set of pinion gears and including a circumferential wall formed in a substantially cylindrical shape around the axial line and a side wall extended radially inward from an end in an axial direction of the circumferential wall. The housing includes a space formation portion configured to form a housing space accommodating the set of pinion gears so as to rotate integrally with the set of pinion gears about the axial line, and the side wall is provided with an opening connecting the housing space and a space outside the housing.

### BRIEF DESCRIPTION OF THE DRAWINGS

The objects, features, and advantages of the present invention will become clearer from the following description of embodiments in relation to the attached drawings, in which:

FIG. 1 is a cross-sectional view of main components of a transmission showing a disposition of a vehicle differential apparatus according to an embodiment of the present invention;

FIG. 2 is a front view showing an external shape of the vehicle differential apparatus alone according to the embodiment of the present invention;

FIG. 3 is a view taken in a direction of an arrow III of FIG. 2;

FIG. 4 is a view taken in a direction of an arrow IV of FIG. 2;

FIG. 5 is a cross-sectional view taken along line V-V of FIG. 4;

FIG. 6 is a cross-sectional view taken along line VI-VI of FIG. 5;

FIG. 7 is a cross-sectional view taken along line VII-VII of FIG. 5; and

FIG. 8 is an enlarged view of main components of FIG. 5.

### DETAILED DESCRIPTION OF THE INVENTION

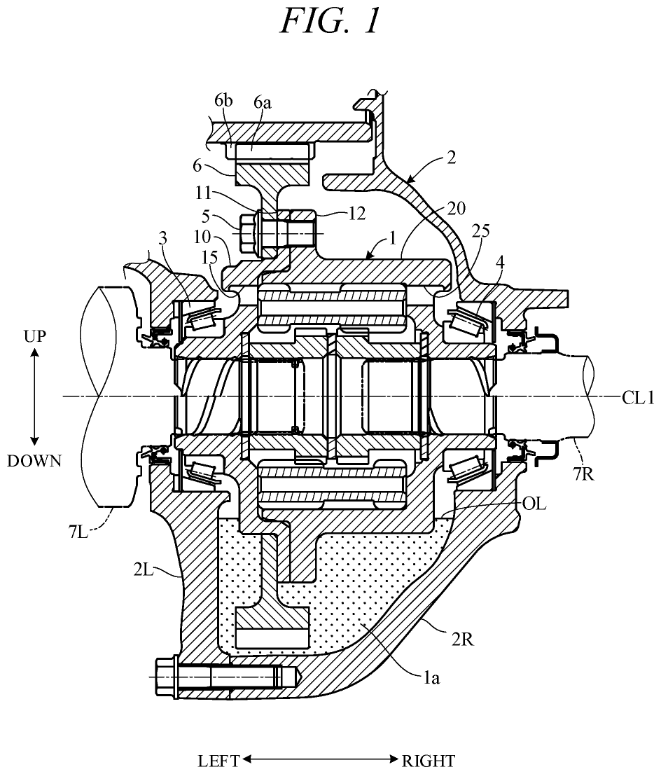

Hereinafter, an embodiment of the present invention is explained with reference to FIGS. 1 to 8. A vehicle differential apparatus according to the embodiment of the present invention is disposed between left and right drive wheels and configured to distribute and transmit a torque from a drive source to the left and right drive wheels. The vehicle differential apparatus may be disposed between front and rear drive wheels and configured to distribute and transmit the torque from the drive source to the front and rear drive wheels. The drive source is, for example, an engine (internal combustion engine). The drive source may be an electric motor. Thus, the vehicle differential apparatus according to the present embodiment can be applied to various types of vehicles, such as vehicles that are driven by the power of an internal combustion engine, vehicles (electric vehicles) that are driven by the power of an electric motor, and vehicles that are driven by the power of both an internal combustion engine and an electric motor (hybrid vehicles).

FIG. 1 is a sectional view of main components of a transmission showing the disposition of the vehicle differential apparatus according to the embodiment of the present invention. For convenience, the up-down direction and the left-right direction are defined as shown in the drawings. The configuration of the components will be described in accordance with this definition. The up-down direction is the height direction of the vehicle, that is, the direction of gravity. The left-right direction is the width direction of the vehicle and is a direction along an axis CL1. Hereafter, a direction along the axis CL1 is referred to as the axial direction, a direction radially extending from the axis CL1 as the radial direction, and a direction along a circle around the axis CL1 as the circumferential direction.

As shown in FIG. 1, the vehicle differential apparatus 1 includes a pair of left and right housings 10 and 20 integrally fastened to each other, and the housings 10 and 20 unitize the entire vehicle differential apparatus 1. The housing 10 on the left side may be referred to as the left housing, and the housing 20 on the right side as the right housing. The vehicle differential apparatus 1 is disposed in a transmission case 2 so as to be rotatable around the axis CL1. More specifically, the transmission case 2 includes a left case 2L on the left side of the vehicle differential apparatus 1 and a right case 2R on the right side thereof. The vehicle differential apparatus 1 is disposed in a housing space 1a between the left case 2L and right case 2R.

The outer circumferential surface of the left end of the left housing 10 is rotatably supported by the left case 2L through a tapered roller bearing 3. The outer circumferential surface of the right end of the right housing 20 is rotatably supported by the right case 2R through a tapered roller bearing 4. The left housing 10 and right housing 20 are fastened to each other by a bolt through flanges 11 and 21. Also, a substantially cylindrical rotor 6 around the axis CL1 is integrally fastened to the flanges 11 and 21 by the bolt 5.

The outer circumferential surface of the rotor 6 is provided with a gear 6a. The gear 6a is engaged with the output gear 6b of the transmission, and the torque from the drive source is inputted to the vehicle differential apparatus 1 through the gears 6a and 6b. A pair of left and right drive shafts 7L and 7R are coupled to the vehicle differential apparatus 1 so as to be rotatable relative to the housings 10 and 20. Rotation inputted to the vehicle differential apparatus 1 is transmitted to the drive shafts 7L and 7R, which then rotationally drive the left and right drive wheels and thus causes the vehicle to travel.

Lubricant oil supplied to the tapered roller bearings 3 and 4 and the like is stored in the bottom portion of the housing space 1a. The oil level OL of the oil is located below the tapered roller bearings 3 and 4 and above the flanges 11 and 21, which are the lowermost portions of the housings 10 and 20. Thus, when the rotor 6 rotates, the rotor 6 and flanges 11 and 21 scoop up the lubricant oil, which then scatters in the housing space 1a.

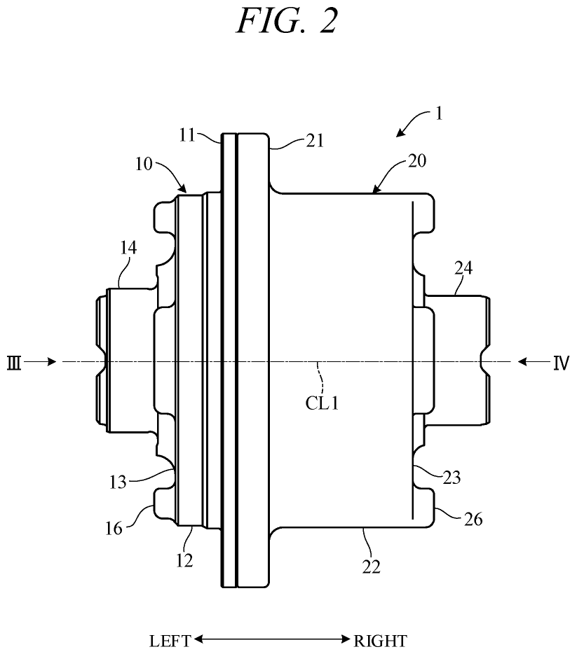

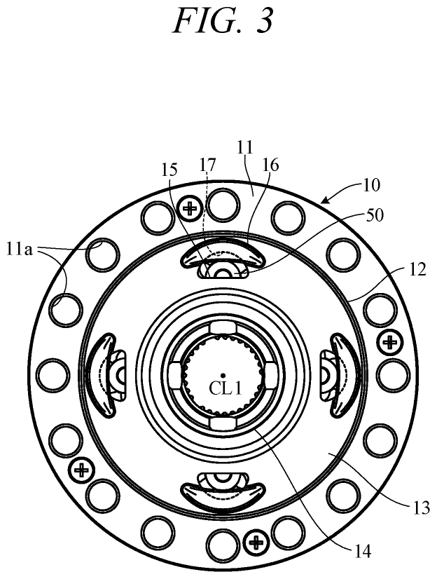

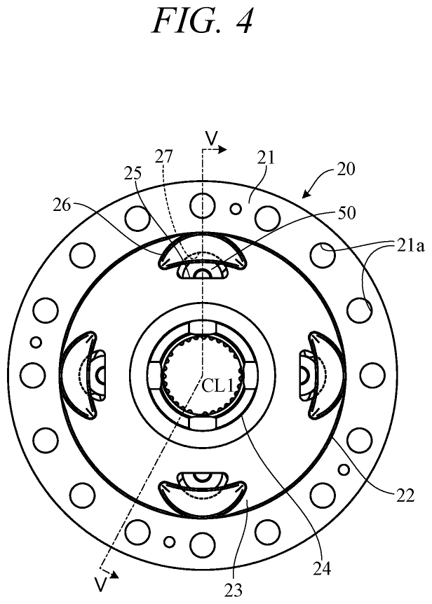

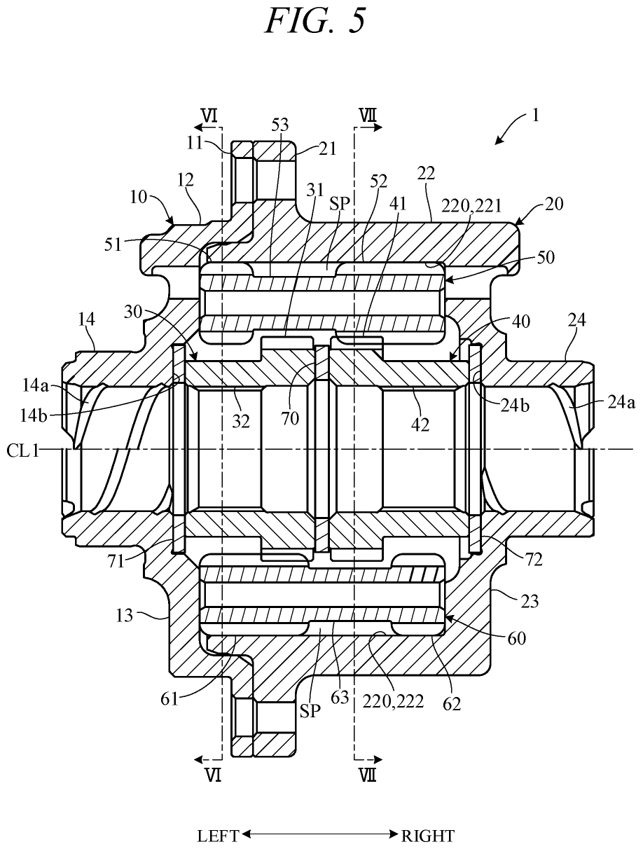

FIG. 2 is a front view showing the external shape of the vehicle differential apparatus 1 alone. FIG. 3 is a left side view of the vehicle differential apparatus 1 (a view taken in the direction of an arrow III of FIG. 2). FIG. 4 is a right side view of the vehicle differential apparatus 1 (a view taken in the direction of an arrow IV of FIG. 2). FIG. 5 is a sectional view showing the configuration of main components of the vehicle differential apparatus 1 (a sectional view taken along line V-V of FIG. 4).

As shown in FIGS. 2, 3, and 5, the left housing 10 includes a substantially cylindrical circumferential wall 12 around the axis CL1, the flange 11 extending radially outward from the right end of the circumferential wall 12, a substantially ring plate-shaped side wall 13 extending radially inward from the left end of the circumferential wall 12, and a cylindrical portion 14 formed in a substantially cylindrical shape around the axis CL1 and extending leftward from the radially inner end of the side wall 13.

Multiple through holes 11a are formed in the flange 11 in the circumferential direction, and bolts 5 (FIG. 1) are inserted in the through holes 11a. The inner circumferential surface of the rotor 6 (FIG. 1) is fitted to the outer circumferential surface of the circumferential wall 12. The inner circumferential surface of the inner ring of the tapered roller bearing 3 (FIG. 1) is fitted to the outer circumferential surface of the cylindrical portion 14. The drive shaft 7L (FIG. 1) is inserted in the cylindrical portion 14. The inner circumferential surface of the cylindrical portion 14 is provided with a helical groove 14a.

As shown in FIGS. 2, 4, and 5, the right housing 20 includes a substantially cylindrical circumferential wall 22 around the axis CL1, the flange 21 extending radially outward from the outer circumferential surface of the circumferential wall 22, a substantially ring plate-shaped side wall 23 extending radially inward from the right end of the circumferential wall 22, and a cylindrical portion 24 formed in a substantially cylindrical shape around the axis CL1 and extending rightward from the radially inner end of the side wall 23.

Multiple screw holes 21a are formed in the flange 21 in the circumferential direction, and the bolts 5 (FIG. 1) are screwed in the screw holes 21a. As shown in FIG. 5, the left end of the circumferential wall 22 protrudes to a more left position than the flange 21, and the outer circumferential surface of the left end is fitted to the inner circumferential surface of the circumferential wall 12 of the left housing 10. The inner circumferential surface of the inner ring of the tapered roller bearing 4 (FIG. 1) is fitted to the outer circumferential surface of the cylindrical portion 24. The drive shaft 7R (FIG. 1) is inserted in the cylindrical portion 24. The inner circumferential surface of the cylindrical portion 24 is provided with a helical groove 24a.

As shown in FIG. 5, the housings 10 and 20 accommodate a pair of substantially cylindrical left and right side gears 30 and 40 around the axis CL. The side gears 30 and 40 are formed so as to be bilaterally symmetrical and have the same inner and outer diameters, axial length, and the like.

Helical gears 31 and 41 are formed in the outer circumferential surfaces of axially inner portions of the side gears 30 and 40, that is, in the outer circumferential surface of a right side portion of the left side gear 30 and the outer circumferential surface of a left side portion of the right side gear 40. The helical gears 31 and 41 have the same gear specifications except that the respective twist directions are opposite. Spline holes 32 and 42 are formed in the inner circumferential surfaces of axially outer portions of the side gears 30 and 40, that is, in the inner circumferential surface of a left side portion of the left side gear 30 and the inner circumferential surface of a right side portion of the right side gear 40. Spline shafts (not shown) on the outer circumferential surfaces of the drive shafts 7L and 7R are fitted into the spline holes 32 and 42 (spline coupling). Thus, the left side gear 30 and drive shaft 7L, and the right side gear 40 and drive shaft 7R rotate integrally.

A substantially ring-shaped washer 70 around the axis CL1 is interposed between the left side gear 30 and right side gear 40. Flange surfaces 14b and 24b are formed on the right end surface of the cylindrical portion 14 of the housing 10 and the left end surface of the cylindrical portion 24 of the housing 20. A substantially ring-shaped washer 71 around the axis CL1 is interposed between the left side gear 30 and flange surface 14b. A substantially ring-shaped washer 72 around the axis CL1 is interposed between the right side gear 40 and flange surface 24b.

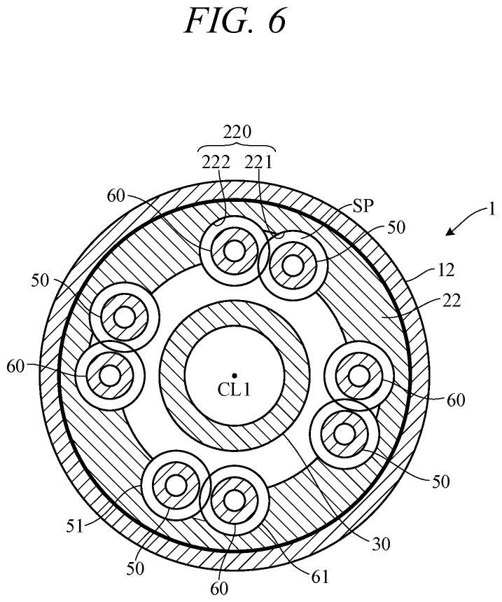

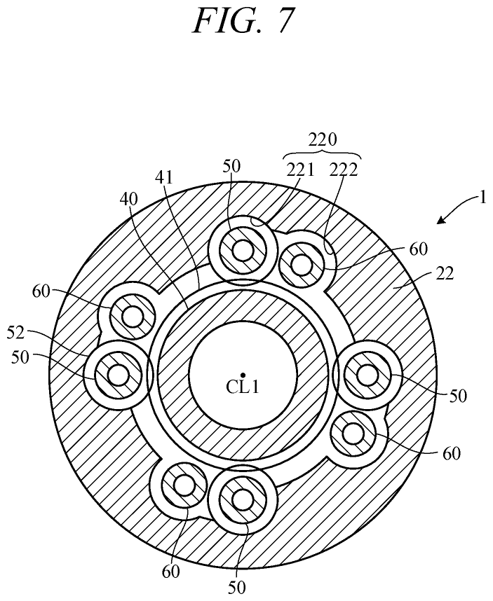

FIG. 6 is a sectional view taken along line VI-VI of FIG. 5, and FIG. 7 is a sectional view taken along line VII-VII of FIG. 5. As shown in FIG. 6, multiple (4 in the figure) recesses (bores) 220 are circumferentially disposed in the inner circumferential surface of the circumferential wall 22 of the substantially cylindrical right housing 20 around the axis CL1. Axially extending, substantially columnar or substantially cylindrical pairs of pinion gears (first pinion gear 50, second pinion gear 60) are disposed side by side in the recesses 220 in the circumferential direction. In other words, the recesses 220 serve as multiple concave housing spaces SP on the radially outside of the side gears 30 and 40, and the pinion gears 50 and 60 are accommodated in the housing spaces SP.

More specifically, each recess 220 includes a first recess 221 formed in a substantially arc shape corresponding to the external shape of a first pinon gear 50 and a second recess 222 formed in a substantially arc shape corresponding to the external shape of a second pinion gear 60. The first recess 221 and second recess 222 are connected in the circumferential direction, and the first pinon gear 50 and second pinion gear 60 are accommodated in the first recess 221 and second recess 222, respectively.

As shown in FIG. 5, the left and right ends of the housing spaces SP are closed by the side walls 13 and 23 of the housings 10 and 20. The pinion gears 50 and 60 have the same axial total length. The axial positions of the pinion gears 50 and 60 are regulated by the side walls 13 and 23, and the circumferential positions thereof are regulated by the recesses 221 and 222.

Helical gears 51 and 52 having the same outer diameter are formed on the left and right ends of the outer circumferential surfaces of the first pinon gear 50. A substantially cylindrical neck 53 having a smaller diameter than the helical gears 51 and 52 is formed between the left and right helical gears 51 and 52. The left helical gear 51 (referred to as the short gear) has a shorter axial length than the right helical gear 52 (referred to as the long gear). The long gear 52 has gear specifications corresponding to those of the helical gear 41 of the right side gear 40 and is engaged with the helical gear 41 (FIG. 7). On the other hand, the helical gear 31 of the left side gear 30 faces the neck 53 through a clearance. Accordingly, the helical gear 31 is not engaged with the first pinon gear 50, and the short gear 51 is located in a more left position than the helical gear 31.

Helical gears 61 and 62 having the same outer diameter are formed on the left and right ends of the outer circumferential surfaces of the second pinon gear 60. A substantially cylindrical neck 63 having a smaller diameter than the helical gears 61 and 62 is formed between the left and right helical gears 61 and 62. The right helical gear 62 (referred to as the short gear) has a shorter axial length than the left helical gear 61 (referred to as the long gear). The long gear 61 has gear specifications corresponding to those of the helical gear 31 of the right side gear 30 and is engaged with the helical gear 31. On the other hand, the helical gear 41 of the right side gear 40 faces the neck 63 through a clearance. Accordingly, the helical gear 41 is not engaged with the second pinon gear 60, and the short gear 62 is located in a more right position than the helical gear 41.

As shown in FIG. 6, the short gear 51 of the first pinon gear 50 and the long gear 61 of the second pinion gear 60 are engaged with each other. Although not shown, the long gear 52 of the first pinon gear 50 and the short gear 62 of the second pinion gear 60 are also engaged with each other. Thus, the torque is transmitted between the left side gear 30 and right side gear 40 through the first pinon gears 50 and second pinion gears 60.

When, in the vehicle differential apparatus 1 thus configured, the torque from the drive source is inputted to the housings 10 and 20 through the rotor 6 of FIG. 1, the housings 10 and 20 rotate around the axis CL1. At this time, the first pinon gears 50 and second pinion gears 60 revolve integrally with the housings 10 and 20 around the axis CL1 without rotating as long as the vehicle is traveling straight ahead and no slip is occurring between the left and right drive wheels and the road surface. Thus, the left and right side gears 30 and 40 rotate at the same speed, resulting in straight ahead travel of the vehicle.

On the other hand, when a slip occurs, for example, on the right drive wheel, the first pinon gears 50 and second pinion gears 60 rotate while being engaged with the side gears 30 and 40. This results in rotation of the left drive wheel at a lower speed than the housings 10 and 20 and rotation of the right drive wheel at a higher speed than the housings 10 and 20. At this time, a thrust force occurs on the side gears 30 and 40 due to the rotation of the first pinon gears 50 and second pinion gears 60. For example, during travel of the vehicle, a thrust force occurs that presses the side gears 30 and 40 inward in the left-right direction; during a deceleration of the vehicle (during engine brake activation), a thrust force occurs that presses the side gears 30 and 40 outward in the left-right direction.

Thus, a friction force (thrust reaction force) occurs between the side gears 30 and 40 and washer 70 or between the side gears 30 and 40 and washers 71 and 72, resulting in limitation of the differential motion of the side gears 30 and 40. Also, during rotation of the first pinon gears 50 and second pinion gears 60, a friction force (radial reaction force) occurs between the first pinon gears 50 and first recesses 221 and between the second pinion gears 60 and second recesses 222. This friction force also limits the differential motion of the side gears 30 and 40.

As described above, the vehicle differential apparatus 1 has the rotatable pinion gears 50 and 60 and side gears 30 and 40 in the housings 10 and 20. For this reason, the lubricant oil has to be supplied to these components. However, the pinion gears 50 and 60 and side gears 30 and 40 are surrounded by the rotatable housings 10 and 20 having the circumferential walls 12 and 22 and side walls 13 and 23 and therefore it is difficult to supply a sufficient amount of lubricant oil to the components in the housings 10 and 20. For this reason, the vehicle differential apparatus 1 according to the present embodiment is configured as follows so that a sufficient amount of lubricant oil can be supplied to the components in the housings 10 and 20.

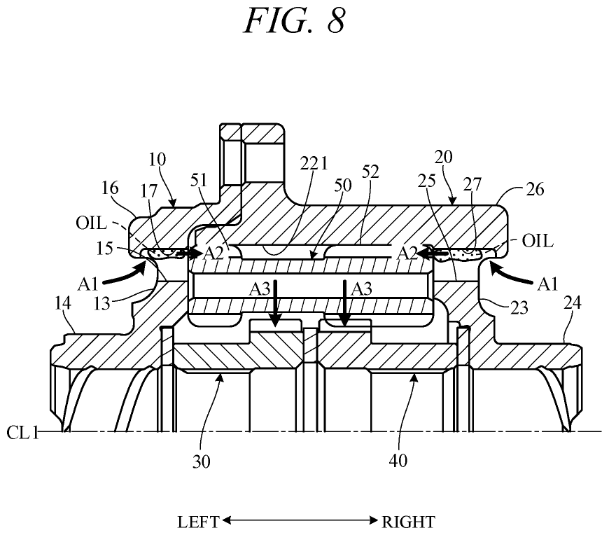

FIG. 8 is an enlarged view of main components of FIG. 5. As shown in FIG. 8, openings 15 and 25 that connect the housing spaces SP in the housings 10 and 20 and spaces outside the housings 10 and 20 are formed in the side wall 13 of the left housing 10 and the side wall 23 of the right housing 20.

As shown in FIGS. 3 and 8, protrusions 16 that protrude leftward are disposed on the radially outer end of the left surface of the side wall 13 and in the same positions in the circumferential direction as the first recesses 221, and the openings 15 are disposed on the radial inside of the protrusions 16. While the protrusions 16 and openings 15 are disposed in four circumferential positions corresponding to all the first recesses 221, the protrusion 16 may be disposed in a circumferential position(s) corresponding to some of the first recesses 221, for example, in one or two positions. The openings 15 and protrusions 16 may also be disposed so as to correspond to the second recesses 222 rather than the first recesses 221.

As shown in FIG. 3, the openings 15 consist of through holes that pass through the side wall 13 in the left-right direction (e.g., substantially rectangular through holes in a front view). The length of each opening 15 in the tangential direction of a circle around the axis CL1 (the length in the cross direction) is longer than the outer diameter of the left end surface of the corresponding first pinon gear 50. On the other hand, the length of the opening 15 in the longitudinal direction perpendicular to the cross direction is shorter than the outer diameter of the left end surface of the first pinon gear 50. That is, the opening 15 is disposed so as to cover the radially inner and outer ends of the left end surface of the first pinon gear 50, and a part of the left end surface of the first pinon gear 50 is exposed through the opening 15. As shown in FIG. 1, the openings 15 are disposed on the radial outside of the tapered roller bearing 3.

As shown in FIGS. 3 and 8, recesses 17 formed in a concave shape radially outward from the openings 15 are disposed on the radially inner end surfaces of the protrusions 16. Each recess 17 is connected to the corresponding opening 15 in a range from a more right position than the left end surface of the corresponding protrusion 16 by a predetermined length to the right end surface of the side wall 13. The recess 17 has substantially the same shape as the corresponding first recess 221 such that the bottom surface thereof is disposed on an extension surface obtained by extending the substantially arc-shaped bottom surface of the first recess 221 leftward, that is, the bottom surface is continuous to the bottom surface of the first recess 221.

As shown in FIGS. 4 and 8, protrusions 26 that protrude rightward are disposed on the radially outer end of the right surface of the side wall 23 and in the same positions in the circumferential direction as the first recesses 221, and the openings 25 are disposed on the radial inside of the protrusions 26. While the protrusions 26 and openings 25 are disposed in four circumferential positions corresponding to all the first recesses 221, the protrusion 26 may be disposed in a circumferential position(s) corresponding to some of the first recesses 221, for example, in one or two positions. The openings 25 and protrusions 26 may also be disposed so as to correspond to the second recesses 222 rather than the first recesses 221. For example, when the openings 15 and protrusions 16 corresponding to the first recesses 221 are disposed on the side wall 13, the openings 25 and protrusions 26 corresponding to the second recesses 222 may be disposed on the side wall 23.

As shown in FIG. 4, the openings 25 consist of through holes that pass through the side wall 23 in the left-right direction (e.g., substantially rectangular through holes in a front view). The length of each opening 25 in the tangential direction of a circle around the axis CL1 (the length in the cross direction) is longer than the outer diameter of the right end surface of the corresponding first pinon gear 50. On the other hand, the length of the opening 25 in the longitudinal direction perpendicular to the cross direction is shorter than the outer diameter of the right end surface of the first pinon gear 50. That is, the opening 25 is disposed so as to cover the radially inner and outer ends of the right end surface of the first pinon gear 50, and a part of the right end surface of the first pinon gear 50 is exposed through the opening 25. As shown in FIG. 1, the openings 25 are disposed on the radial outside of the tapered roller bearing 4.

As shown in FIGS. 4 and 8, recesses 27 formed in a concave shape radially outward from the openings 25 are disposed on the radially inner end surfaces of the protrusions 26. Each recess 27 is connected to the corresponding opening 25 in a range from a more left position than the right end surface of the corresponding protrusion 26 by a predetermined length to the left end surface of the side wall 23. The recess 27 has substantially the same shape as the corresponding first recess 221 such that the bottom surface thereof is disposed on an extension surface obtained by extending the substantially arc-shaped bottom surface of the first recess 221 rightward, that is, the bottom surface is continuous to the bottom surface of the first recess 221.

The main operation of the vehicle differential apparatus 1 according to the present embodiment of the present invention will be described. When the housings 10 and 20 rotate in the housing space 1a (FIG. 1) of the transmission case 2, the lubricant oil in the transmission case 2 is scooped up by the protrusions 16 of the left housing 10 and the protrusions 26 of the right housing 20. Thus, as shown by arrows A1 of FIG. 8, the lubricant oil is supplied to the recesses 17 of the protrusions 16 and the recesses 27 of the protrusions 26 and accumulated therein by a centrifugal force. The lubricant oil is also scooped up by the rotor 6, flanges 11 and 21, and the like and scattered in the housing space 1a. The scattered lubricant oil is also captured by the recesses 17 and 27 and accumulated therein.

When the first pinon gears 50 rotate in this state, the lubricant oil in the recesses 17 and 27 moves inward in the left-right direction along the tooth grooves of the helical gears 51 and 52 on the outer circumferential surface of the first pinon gears 50 and is supplied to the first pinon gears 50, as shown by arrows A2 of FIG. 8. The lubricant oil supplied to the first pinon gears 50 is supplied to other components in the housings 10 and 20, that is, the adjacent second pinion gears 60 and side gears 30 and 40, as shown by arrows A3 of FIG. 8. As seen above, a sufficient amount of lubricant oil is supplied to the components in the housings 10 and 20, allowing the vehicle differential apparatus 1 to operate favorably.

As shown in FIG. 5, the helical grooves 14a and 24a are disposed in the inner circumferential surfaces of the cylindrical portions 14 and 24 of the housings 10 and 20. Thus, when a rotation difference occurs between the cylindrical portions 14 and 24 and the drive shafts 7L and 7R (FIG. 1) during rotation of the pinion gears 50 and 60, the lubricant oil is guided to the housings 10 and 20 through the grooves 14a and 24a. For example, the lubricant oil flows onto the outer circumferential surfaces of the drive shafts 7L and 7R along the left side surface of the tapered roller bearing 3 and the right side surface of the tapered roller bearing 4 and then is guided into the housings 10 and 20 through the grooves 14a and 24a.

According to the embodiment, the following operations and effects can be achieved.

(1) The vehicle differential apparatus 1 includes the pair of substantially cylindrical side gears 30 and 40 disposed side by side along the axis CL1 so as to rotate around the axis CL1; the pairs of pinion gears 50 and 60 disposed on the radial outside of the pair of side gears 30 and 40, engaged with one of the side gears 30 and 40, and engaged with each other; and the housings 10 and 20 having the substantially cylindrical circumferential walls 12 and 22 around the axis CL1 and the side walls 13 and 23 extending radially inward from both axial ends of the circumferential walls 12 and 22 and accommodating the pair of side gears 30 and 40 and the pairs of pinion gears 50 and 60 (FIG. 5). The housing 20 (circumferential wall 22) has the recesses 220 forming the housing spaces SP for accommodating the pairs of pinion gears 50 and 60 so as to rotate integrally with the pairs of pinion gears 50 and 60 around the axis CL1 (FIGS. 6 and 7). The side walls 13 and 23 are provided with the openings 15 and 25 that face the housing spaces SP and connect the housing spaces SP and the spaces outside the housings 10 and 20 (FIG. 8).

Therefore, when the first pinon gears 50 rotate, it is possible to guide the lubricant oil passed through the openings 15 and 25 into the housings 10 and 20 along the helical gears 51 and 52 and thus to sufficiently supply the lubricant oil to the components (pinion gears 50 and 60, side gears 30 and 40) in the housings 10 and 20, allowing the vehicle differential apparatus 1 to operate favorably.

(2) The side walls 13 and 23 have the protrusions 16 and 26 that protrude axially outward (FIG. 8). The protrusions 16 and 26 are provided continuously to the openings 15 and 25 and have the recesses 17 and 27 formed in substantially concave shapes oriented to the radial outside (FIG. 8). Thus, the lubricant oil on which a centrifugal force is acting is accumulated in the vicinity of the openings 15 and 25 and is favorably guided into the housings 10 and 20.

(3) The bottom surfaces of the first recesses 221 and the bottom surfaces of the recesses 17 and 27 are disposed in the same positions in the radial and circumferential directions so that both bottom surfaces are extended continuously in the axial direction (FIGS. 3, 4 and 8). Thus, it is possible to smoothly guide the lubricant oil accumulated in the recesses 17 and 27 into the housings 10 and 20.

(4) The openings 15 and 25 are formed in the pair of left and right side walls 13 and 23 of the housings 10 and 20 (FIG. 8). Thus, a sufficient amount of lubricant oil is guided from both axial sides of the housings 10 and 20 into the housings 10 and 20.

(5) The housings 10 and 20 are supported in the transmission case 2 storing the lubricant oil so as to be rotatable around the axis CL1 through the cylindrical portions 14 and 24 (FIGS. 1 and 5). Thus, when the housings 10 and 20 rotate, the lubricant oil stored in the housing space 1a of the transmission case 2 is scooped up. Therefore, it is possible to easily guide the lubricant oil into the openings 15 and 25.

The above embodiment can be modified into various forms. Hereafter, modifications will be described. Although, in the above embodiment, the left and right side walls 13 and 23 of the housings 10 and 20 are provided with the openings 15 and 25, one of the side walls 13 and 23 may be provided with openings facing housing spaces SP. Although, in the above embodiment, the openings 15 and 25 are disposed so as to face the first pinon gears 50, openings may be disposed so as to face the second pinion gears 60 or may be disposed so as to face both the first pinon gears 50 and second pinion gears 60. For example, openings may be disposed so as to face the areas in which the pinion gears 50 and 60 are engaged with each other. That is, openings need not be disposed in the above-mentioned positions as long as the openings are disposed in the side walls 13 and 23 so as to connect the housing spaces SP and the spaces outside the housings 10 and 20.

Although, in the above embodiment, the pair of pinion gears 50 and 60 engaged with each other. i.e., the first pinon gears 50 and second pinion gears 60 are disposed on the radial outside of the side gears 30 and 40, the number of pinion gears 50 and 60 may be three or more. For example, a pair of second pinion gears may be disposed such that both sides in the circumferential direction of one first pinion gear are sandwiched between the pair of second pinion gears. In this case, the first pinon gears 50 may be formed so as to be longer or shorter in the axial direction than the second pinion gears 60. That is, a set of pinion gears may have any configuration as long as the set of pinion gears are disposed on the radial outside of the pair of side gears, engaged with one and the other of the pair of side gears, and engaged with each other. Although, in the above embodiment, the recesses 220 accommodating the set of pinion gears 50 and 60 are disposed in the inner circumferential surface of the circumferential wall 22 of the right housing 20, a space formation portion need not have the above configuration as long as it accommodates the set of pinion gears 50 and 60 so as to rotate integrally with the housings.

Although, in the above embodiment, the side walls 13 and 23 of the housings 10 and 20 are provided with the protrusions 16 and 26 that protrude axially outward and the protrusions 16 and 26 are provided with the recesses 17 and 27 oriented to the radial outside, an oil receiver is not limited to this configuration. Although, in the above embodiment, the vehicle differential apparatus 1 is disposed in the housing space 1a of the transmission case 2, the vehicle differential apparatus may be disposed in another case storing lubricant oil.

The above embodiment can be combined as desired with one or more of the above modifications. The modifications can also be combined with one another.

According to the present invention, it is possible to efficiently supply lubricant oil in a rotating housing of a vehicle differential apparatus.

Above, while the present invention has been described with reference to the preferred embodiments thereof, it will be understood, by those skilled in the art, that various changes and modifications may be made thereto without departing from the scope of the appended claims.

What is claimed is:

1. A vehicle differential apparatus comprising:
a pair of side gears arranged side by side with each other along an axial line and formed in substantially cylindrical shapes so as to rotate about the axial line;
a set of pinion gears disposed on a radial outside of the pair of side gears so that one of the set of pinion gears engages with one of the pair of side gears, the other of the set of pinion gears engages with the other of the pair of side gears, and the set of pinion gears engage with each other; and
a housing configured to accommodate the pair of side gears and the set of pinion gears and including a circumferential wall formed in a substantially cylindrical shape around the axial line and a side wall extended radially inward from an end in an axial direction of the circumferential wall, wherein
the housing includes a space formation portion configured to form a housing space accommodating the set of pinion gears so as to rotate integrally with the set of pinion gears about the axial line, and
the side wall is provided with an opening connecting the housing space and a space outside the housing.

2. The vehicle differential apparatus according to claim 1, wherein
the side wall includes a protrusion protruded outward in the axial direction, and
the protrusion includes an oil receiver provided continuously to the opening and formed in a substantially concave portion.

3. The vehicle differential apparatus according to claim 2, wherein
a bottom surface of the space formation portion and a bottom surface of the oil receiver are located at a same position in a circumferential direction and a radial direction around the axial line.

4. The vehicle differential apparatus according to claim 1, wherein
the housing includes a pair of side walls extended radially inward from both ends in the axial direction of the circumferential wall, and
each of the pair of side walls is provided with the opening.

5. The vehicle differential apparatus according to claim 1, wherein
the housing is disposed rotatably about the axial line in a case storing a lubricant oil.

6. The vehicle differential apparatus according to claim 1, wherein
the pair of side gears are a first side gear and a second side gear,
the set of pinion gears are a first pinion gear having a pair of first helical gears and a second pinion gear having a pair of second helical gears,
the pair of first helical gears are a first helical gear at a first end in the axial direction and a first helical gear at a second end in the axial direction,
the pair of second helical gears are a second helical gear at a first end in the axial direction and a second helical gear at a second end in the axial direction, and
the set of pinion gears are configured so that the first helical gear at the second end engages with the second side gear, the second helical gear at the first end engages with the first side gear, the first helical gear at the first end engages with the second helical gear at the first end, and the first helical gear at the second end engages with the second helical gear at the second end.

7. The vehicle differential apparatus according to claim 6, wherein
the first helical gear at the first end is formed shorter than the first helical gear at the second end in the axial direction, and
the second helical gear at the first end is formed longer than the second helical gear at the second end in the axial direction.

8. The vehicle differential apparatus according to claim 1, wherein
the vehicle differential apparatus is disposed between a left and right driving wheels so as to distribute and transmit a torque from a drive source to the left and right driving wheels.

9. The vehicle differential apparatus according to claim 1, wherein
the housing includes a cylindrical portion formed in a cylindrical shape around the axial line and extended toward an outside in the axial direction from an end on an inner diameter side of the side wall, and
the cylindrical portion is provided with a spiral groove on an inner circumferential surface of the cylindrical portion.
